(19) United States
(12) Patent Application Publication
(10) Pub. No.: US 2018/0293751 A1
(43) Pub. Date: Oct. 11, 2018

(54) MEASURING APPARATUS AND CORRESPONDING MEASURING METHOD

(71) Applicant: Testo SE & Co. KGaA, Lenzkirch (DE)

(72) Inventors: Jan-Friso Evers-Senne, Titisee-Neustadt (DE); Robert Wulff, Freiburg (DE); Dominik Wolters, Flintbek (DE)

(73) Assignee: Testo SE & Co. KGaA, Lenzkirch (DE)

(21) Appl. No.: 15/946,187

(22) Filed: Apr. 5, 2018

(30) Foreign Application Priority Data
Apr. 5, 2017 (DE) 102017107336.1

(51) Int. Cl. G06T 7/60; G01B 11/02; G06T 7/11; G06T 7/13; G06K 9/52; G06T 7/215; G06T 7/246; G06F 3/0488; G06T 17/00

(52) U.S. Cl. CPC G06T 7/60; G01B 11/02; G06T 7/11; G06T 7/13; G06K 9/52; G06T 2207/10016; G06T 7/251; G06F 3/0488; G06T 7/248; G06T 17/00; G06T 2207/20104; G06T 7/215

(57) ABSTRACT

A measuring apparatus (1) for measuring at least one geometric variable (h), and to a corresponding measuring method are provided. The measuring apparatus (1) is preferably designed as a handheld apparatus for creating a dimensional measurement of an examination object (3). The measuring method according to the invention is distinguished by the fact that from a sequence of images, preferably recorded by a camera (5), both robust features (9) and precise features (13) to be distinguished therefrom in a regular manner are detected, such that a robust 3D model is created and precise information about the geometric variable (h) to be measured is calculated.

### INCORPORATION BY REFERENCE

The following documents are incorporated herein by reference as if fully set forth: German Patent Application No. 10 2017 107 336.1, filed Apr. 5, 2017.

### BACKGROUND

The invention relates to a measuring apparatus for measuring at least one geometric variable of an examination object.

The measured geometric variable can be for example a length or area measure of a characteristic feature of the examination object, for instance of a building.

### SUMMARY

According to the invention, the measuring apparatus comprises a camera, which can be used to carry out a recording of a sequence of images of the examination object. In this case, it may be useful to vary the position of the camera between the individual recordings of the images, in order to record the examination object from different viewing angles.

Furthermore, the measuring apparatus comprises a processor configured for computer-aided detection of robust features by feature recognition from the images of the sequence. The robust features are distinguished by the fact that they are suitable for identification of, in terms of contents, corresponding image regions among the images of the sequence. The robust features can be formed for example by a property of a contour or of an area, for example a colour or a contrast. A direct relation to the variable to be measured need not exist here.

Furthermore, the measuring apparatus is configured for computer-aided identification of corresponding image regions among the images by the detected robust features and computer-aided generation of a 3D model from the result of the identification.

The invention furthermore relates to a measuring method for measuring at least one geometric variable on an examination object, comprising the following steps:
recording a sequence of images of the examination object,
computer-aided detection of robust features by feature recognition from the images of the sequence, wherein the robust features are suitable for identification of, in terms of contents, corresponding image regions among the images of the sequence,
computer-aided identification of corresponding image regions among the images by the extracted robust features and computer-aided generation of a 3D model from the result of the identification.

According to the invention, the measuring apparatus can be designed or designated as a dimensional measurement apparatus.

Measuring apparatuses and methods having the features described initially have been proposed for carrying out dimensional measurements as simply as possible.

A dimensional measurement of an object, in particular of a building, is required in order to calculate for example work performed by tradespeople. The dimensional measurement involves measuring the dimensions of all relevant structural parts and extensions.

This is generally carried out manually using a rule or a tape measure or with the aid of a laser distance measuring apparatus. Such manual recording of a dimensional measurement can be extremely complicated. Moreover, in the case of relatively large objects, for instance in the case of multi-storey buildings, it may be necessary to install a scaffold in order to measure windows at the top, for instance.

In order to reduce this high complexity/outlay, a measuring apparatus as described initially could be used. However, the user in this case still has to manually select in the 3D model points or the like in respect of which the geometric variable is intended to be calculated. This is still time-consuming and furthermore demands a great deal of experience. Moreover, the result may be beset by high measurement inaccuracies.

The invention is based on the object of simplifying dimensional measurements.

This objective is achieved using one or more features of the invention. In particular, therefore, for achieving the stated objective, in the case of a measuring apparatus of the type described initially, the invention provides that the processor is configured for computer-aided detection of precise features by corner and/or edge detection from the images of the sequence.

The precise features can be, in particular, accurately localizable features in the images of the sequence, which need not necessarily also be suitable for the assignment of corresponding image regions among the images of the sequence. It may be advantageous if the precise features are necessary or at least useful for the calculation of the geometric variable. By way of example, point features, in particular as intersection points of lines, and/or line features are considered as precise features. Such features may be formed for example by a border of a window frame which comprises corners and straight or curved margins.

The robust features used in the invention may be characterized for example by the fact that they are scale-invariant features. This enables identification of corresponding image contents independently of, for example, a recording distance. By contrast, the precise features used in the invention may be characterized for example by the fact that they allow pixel-accurate or even subpixel-accurate localization in the respective image. Such precise features are particularly suitable in the course of obtaining a geometric variable according to the invention, in which the precise features define the geometric variable. It may generally be stated that in a configuration of the invention the robust features allow a higher probability of identification in a further image, while the precise features allow more accurate localization of the feature in the individual image.

The solution mentioned above furthermore provides that a selection device designed for selecting a set of precise features, and that the processor is configured for computer-aided calculation of the geometric variable from the set of precise features in the 3D model. In this case, the selection can comprise all or a portion of the detected precise features.

This technical solution simplifies dimensional measurements since it obviates manual selection of precise features required for the calculation of the geometric variable. The advantages of the use of robust, but possibly imprecise, and simultaneously precise, but possibly non-robust, features are optimally combined with one another in the present invention.

In one configuration of the invention it may be provided that the detection of the precise features is carried out from edge detection, in particular straight line or segment detection, and subsequent intersection point calculation. Edges are detectable more accurately in an image, with the result that the precision of the precise features is increased by the intersection point formation.

In one configuration of the invention it may be provided that the measuring apparatus is designed as a handheld apparatus, preferably having an integrated camera and/or an integrated processor. However, it may also be provided that the handheld apparatus only has means for transferring data from an external camera. It may be particularly advantageous if a power supply unit for the camera and/or for the processor is integrated. Such a handheld apparatus affords the advantage that it is usable in an uncomplicated manner by anybody directly at the site of use.

In order to improve the measurement accuracy, in one configuration of the invention it may be provided that exposure parameters of the camera are controllable or are controlled. Preferably, the control is based on a recorded image of a reference object, in particular on grey-scale values in said image. It may be provided that image brightnesses in the sequence of images are adapted in order to correct inaccuracies of the camera or the exposure control. Furthermore, it may be provided that the camera has a large aperture angle and/or comprises a fisheye lens and/or has means for imaging and/or outputting intrinsic camera parameters and/or other information.

In order to further improve the measurement accuracy, in a further configuration of the invention it may be provided that the measuring apparatus or the camera is designed to record an orientation of the measuring apparatus and/or of the camera, in particular by gravitational force sensor and/or compass, a rate of rotation and/or acceleration of the camera or of the measuring apparatus and/or an ambient temperature. In a corresponding measuring method it may be provided that a direction of a gravitational force, cardinal point, rate of rotation, acceleration or temperature is recorded. Knowledge of an orientation of the measuring apparatus or of the camera can be used for example to orient the generated 3D model. Knowledge of the ambient temperature can be used for example to calculate a thermal expansion of a reference object in order thus to obtain more accurate scaling data.

In order to improve the evaluation result, in a further configuration of the invention it may be provided that the processor is configured for calculation of 3D coordinates in the 3D model at least for the set of precise features. This can be carried out by triangulation from the geometric coordinate information of the 3D model. An improved calculation can be carried out if, alternatively or additionally, corresponding precise features from a plurality of images of the sequence are assigned, for example using descriptors and/or camera information, such as, for instance, concerning an epipolar geometry or concerning extrinsic or intrinsic camera parameters, and/or neighbourhood relations to other precise and/or robust features.

In order to simplify the operational control of the measuring apparatus and/or in order to communicate information, in a further configuration it may be provided that a device for outputting information, preferably a display, are provided. The measuring apparatus can be configured for example to display a recorded or registered image, robust or precise features, a generated 3D model, a distance to the examination object or to a reference object, a size of the examination object, a measured geometric variable, an accuracy of the measured geometric variable, a position and/or accuracy of the position of a calculated 3D coordinate of a feature, or other information possibly relevant to the user.

In order to simplify the interaction with the measuring apparatus, in a further configuration of the invention it may be provided that the selection means are configured for outputting the extracted precise features for a user. In this case, it may be provided, in particular, that the selection device includes a display. Preferably, the display is touch-sensitive and/or equipped with a controllable cursor. It may be advantageous if the measuring apparatus is configured for outputting the precise features in a 2D view and/or 3D view.

In a further configuration of the invention it may be provided that the processor is configured for fitting a geometric object into the 3D coordinates of the set of precise features for the calculation of the geometric variable. The geometric object may be for example a rectangle, a pyramid, a circular arc section or any other arbitrary shape. It may be advantageous if the processor is configured for determining and outputting suitable geometric objects in a computer-aided manner for selection. The fitting of a suitable geometric object supports the user in the definition of a measurement specification and may lead to an increase in the measurement accuracy.

In order to be able to estimate the quality of the fitting and to be able to derive follow-up measures therefrom, in one variant of the configuration of the invention just described it may be provided that the processor is configured for evaluating an inaccuracy measure from the fitted geometric object and the 3D coordinates of the set of precise features.

In this case, it may be advantageous if the processor is configured for automatically fitting an alternative geometric object if the evaluated inaccuracy measure exceeds a limit value. By virtue of the fact that the measuring apparatus thus automatically fits an alternative geometric object in the event of initially inadequate selection of a geometric object, it is possible to improve the quality of the fitting.

It may furthermore be advantageous if the processor is configured for issuing warning information if the evaluated inaccuracy measure exceeds a limit value. If automatic fitting of an alternative geometric object is not provided, this may have the advantage, for example, that the user of the measuring apparatus can then himself/herself decide whether an alternative geometric object is intended to be fitted or whether supplementary image recordings are intended to be carried out. Even if automatic fitting of alternative geometric objects has been carried out, issuing warning information may be advantageous since the user of the measuring apparatus can thereby be notified for example that the measurement accuracy is currently low and supplementary image recordings should therefore be carried out.

It may furthermore be advantageous if the processor is configured to display the evaluation result of the inaccuracy measure and/or to define or change the limit value. This can preferably be carried out by a factory setting or by the user of the measuring apparatus himself/herself. It is then possible to decide whether a measurement that was carried out was sufficiently reliable or whether further images of the examination object should be recorded.

In order to improve the measurement accuracy, in a further configuration of the invention it may be provided that the processor is configured to carry out a correction calculation in which information about the robust point features and/or the precise point features and/or a or the reference object and/or an ambient temperature and/or a camera parameter is utilized by the introduction of an error function comprising adapted weightings and boundary conditions for the utilized information.

In a further configuration of the invention it may be provided that the processor is configured for extracting descriptors for the robust features for the identification of the corresponding image regions. Specifically, the information provided by the descriptors can lead in particular to more reliable creation of a 3D model on the basis of which 3D coordinates of the precise features used for the calculation of the geometric variable can be calculable.

In order to improve the measurement accuracy, in one configuration of the invention it may be provided that the processor is configured for registration of the images of the sequence for the generation of the 3D model. Specifically, as a result of the registration, the 3D model can be particularly reliable and thus form a good data basis for the calculation of the geometric variable.

In order to generate a 3D model that is as accurate as possible and thus in order to improve the measurement accuracy, as an alternative or in addition thereto it may be provided that the processor is configured for applying a structure-from-motion method to the images of the sequence for the generation of the 3D model.

In order to further improve the measurement accuracy, in one configuration of the invention it may be provided that the processor is configured for extracting descriptors of the precise features for the calculation of the 3D coordinates of the set of precise features. The use of descriptors enables precise features of different image recordings to be assigned better. The measurement accuracy can thus be improved.

In order to improve the measurement accuracy, in one configuration of the invention it may be further provided that the processor is configured for calculation of the 3D coordinates on the basis of photometric similarities of the precise features among the images of the sequence. Preferably, the calculation is carried out on the basis of descriptors of the precise features.

In order to further improve the measurement accuracy, in one configuration of the invention it may alternatively or additionally be provided that the processor is configured for subpixel-accurate calculation of the 2D coordinates of the precise features in the images.

In order to obtain absolute values for the geometric variable, in one configuration of the invention it may be provided that a scaling unit is configured for scaling the 3D model by evaluating a reference object recorded in the images of the sequence. Preferably, scaling information about the reference object is measurable or known in this case. The reference object may be for example a reference table and/or at least one marker.

In one configuration of the invention, as an alternative or in addition to the previous configuration, it may be provided that a scaling unit, for example the scaling unit already mentioned above, is configured for scaling the 3D model by at least one distance measurement with respect to the examination object. By use of distance measurements it is possible to obtain scaling information on the basis of which absolute values for the geometric variable to be measured can be determined.

In one configuration of the invention it may be provided that the processor is configured for calculation of a camera pose for an image from the sequence of images, in particular wherein a reference object is recorded in the image.

In addition, a measuring method is also provided having one or more features of the invention for achieving the stated object. In particular, therefore, for achieving the stated object, in the case of a measuring method of the type described initially, the invention proposes the following further steps:
computer-aided detection of precise features by corner and/or edge detection from the images of the sequence,
selecting a set of precise features, and
computer-aided calculation of the geometric variable from the set of precise features in the 3D model.

This measuring method thus has technical features which may correspond to the technical features which the above-described measuring apparatus according to the invention has. The measuring method thus shares in particular the advantages which the measuring apparatus, too, has over the previously known prior art. In this respect, reference is made to the description of advantages above.

Configurations of the measuring method according to the invention are described below. Apart from a few exceptions, these configurations correspond to the configurations of the measuring apparatus according to the invention which have already been described above, and therefore have in particular the same advantages which corresponding configurations of the measuring apparatus have. With regard to the description of advantages of the configurations of the measuring method that are described below, therefore, reference is made to the description of the advantages of the corresponding configurations of the measuring apparatus.

In one configuration of the invention it may be provided that the precise features are determined as intersection points of edges of edge detection, in particular straight line or segment detection. This has the advantage, in particular, that edges in an image can be determined significantly more precisely and, consequently, the precise point features obtained as an intersection point are thus also localized more accurately.

In one configuration of the invention it may be provided that at least for the set of precise features associated 3D coordinates in the 3D model are calculated in a computer-aided manner. This can preferably be carried out as already described above.

In a further configuration of the invention it may be provided that information is output. This can be carried out via a display, for example. The information that is output can be, in particular, the information already described above.

In one configuration of the invention it may be provided that the detected precise features are output for a user for selection. In this case and also generally it may be provided that the user can select all precise features or else only a portion of the detected precise features.

In one configuration of the invention it may be provided that for calculation of the geometric variable a geometric object is fitted into the 3D coordinates of the set of precise features in a computer-aided manner. In particular, it may be provided in this case that suitable geometric objects are determined in a computer-aided manner and offered to a user for selection.

In one configuration of the invention it may be provided that an inaccuracy measure, in particular a distance measure, from the fitted geometric object and the 3D coordinates of the set of precise features is evaluated, in particular wherein warning information is issued or an alternative geometric object is automatically fitted if the evaluated inaccuracy measure exceeds a limit value.

It may be advantageous if the evaluation result of the inaccuracy measure is displayed in a manner discernible to the user of the measuring method. Alternatively or additionally, it may be provided that a factory setting and/or the user define(s) or change(s) the limit value.

In one configuration of the invention it may be provided that a correction calculation is carried out as described above.

In one configuration of the invention it may be provided that for identification of the corresponding image regions descriptors for the robust features are extracted in a computer-aided manner.

In one configuration of the invention it may be provided that for generation of the 3D model the images of the sequence are brought to registration in a computer-aided manner.

As an alternative or in addition thereto, it may be provided that for generation of the 3D model a computer-aided structure-from-motion method is applied to the images of the sequence.

In one configuration of the invention it may be provided that for calculation of the 3D coordinates of the set of precise features descriptors of the precise features are extracted in a computer-aided manner.

In one configuration of the invention it may be provided that the 3D coordinates are calculated on the basis of photometric similarities of the precise features among the images of the sequence. Preferably, this is done on the basis of descriptors of the precise features.

In one configuration of the invention it may be provided that the 2D coordinates of the image positions of the precise features are calculated with subpixel accuracy.

In one configuration of the invention it may be provided that point features are used as precise features. Alternatively or additionally, it may be provided that line features are used as precise features. Line features can be determined particularly precisely and often define geometric variables of interest in the case of examination objects. Precise point features can arise from the intersection of said line features. Therefore, this type of features is particularly well suited as precise features, such that a multiplicity of relevant and accurate geometric variables can be measured.

In one configuration of the invention it may be provided that scaling of the 3D model is calculated in a computer-aided manner by evaluating a reference object recorded in the images of the sequence.

As an alternative or in addition thereto, it may be provided that a scaling of the 3D model is calculated in a computer-aided manner by at least one distance measurement with respect to the examination object.

### BRIEF DESCRIPTION OF THE DRAWINGS

The invention will now be described in more detail on the basis of one or a few exemplary embodiments, but is not restricted to said few exemplary embodiments. Further exemplary embodiments result from combination of the features of individual or a plurality of claims among one another and/or with individual or a plurality of features of the exemplary embodiments.

In the figures:

FIG. 1 shows a perspective of a measuring apparatus according to the invention, which measuring apparatus can be used to measure at least one geometric variable of an examination object;

FIG. 2 shows the measuring apparatus shown in FIG. 1 from a different perspective;

FIG. 3 shows a flow diagram of a measuring method according to the invention for measuring at least one geometric variable;

FIG. 4 shows a house façade to be measured with a selection of detected robust features;

FIG. 5 shows the house façade shown in FIG. 4 with a selection of detected precise features;

FIG. 6 shows an illustration for the calculation of a height of a window of the house façade shown in FIG. 4 and FIG. 5,

FIG. 7 shows a side view of a second embodiment of a measuring apparatus according to the invention, and

FIG. 8 shows a front view of the measuring apparatus from FIG. 7.

### DETAILED DESCRIPTION OF THE PREFERRED EMBODIMENTS

In the following description of various exemplary embodiments of the invention, elements that correspond in terms of their function are provided with reference signs that correspond even in the case of deviating design or shaping.

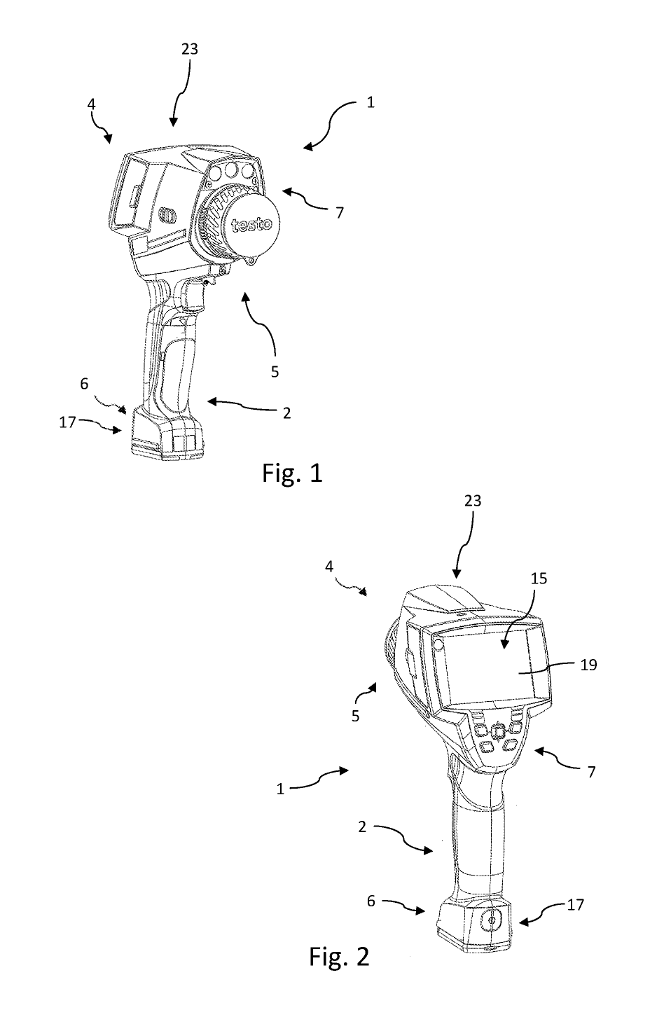

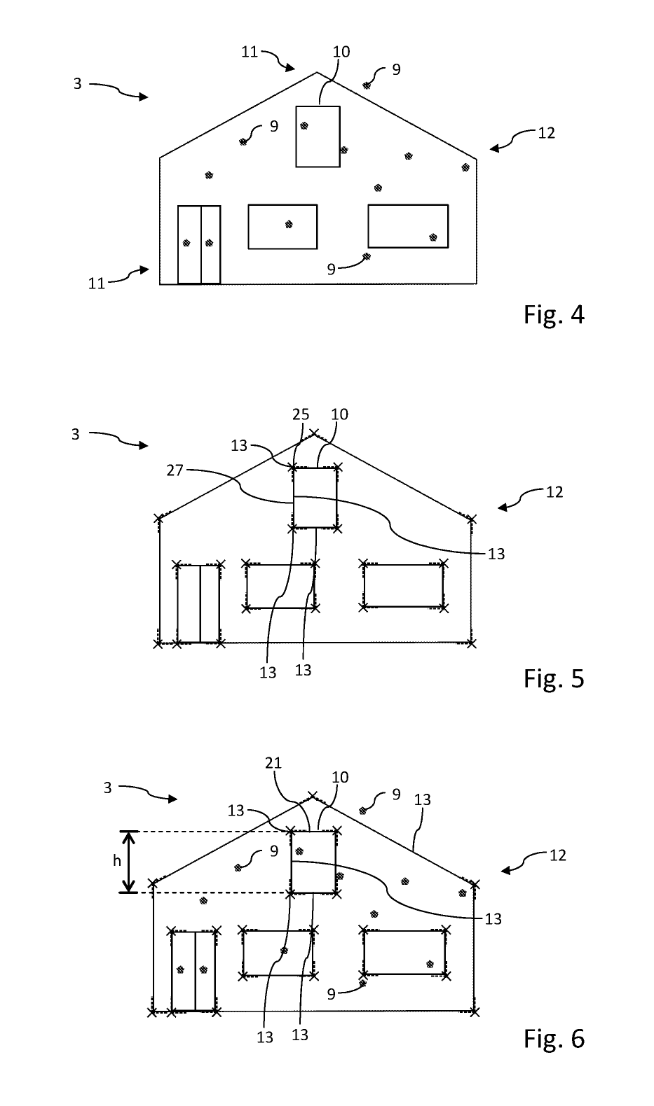

FIG. 1 and FIG. 2 show different perspectives of a measuring apparatus 1 according to the invention. The measuring apparatus 1 can be used to measure geometric variables of an examination object. The measuring apparatus 1 is particularly suitable as a dimensional measurement apparatus which can be used to create dimensional measurements of buildings, for example the dimensional measurement of the house façade 12 shown in FIG. 4 to FIG. 6. The measuring apparatus 1 is a handheld apparatus comprising an ergonomically designed handle region 2 for gripping, holding and operating the handheld apparatus. The external design and/or the internal construction of the measuring apparatus 1 can deviate from that/those shown here in further exemplary embodiments.

A camera 5 is implemented on the head 4 of the measuring apparatus 1, which camera can be used to record sequences of images of the examination object 3. In order to create a sequence of images, the user of the measuring apparatus 1, for example a tradesperson, can record images of the examination object 3 from different positions. The recorded image data are then buffer-stored in a memory and transmitted to a processor 7, which is arranged in the head 4 of the measuring apparatus. Furthermore, a display 19 is implemented on the head 4, on which display output data processed and output by the processor 7 are able to be imaged in a 2D or 3D view depending on the setting. The display 19 is touch-sensitive, such that interaction with the output data imaged is possible. In particular, by touching the display 19 it is possible to select displayed pixels and lines which can form precise features 13. In this respect, the display 19 is thus a selection device 15, which is designed in particular for selection of a set of precise features 13.

A power supply unit 17 forming a rechargeable battery is implemented on the foot 6 or handle of the measuring apparatus 1. The power supply unit 17 supplies the camera 5 and the data processing system 7 with the electric current required for operation.

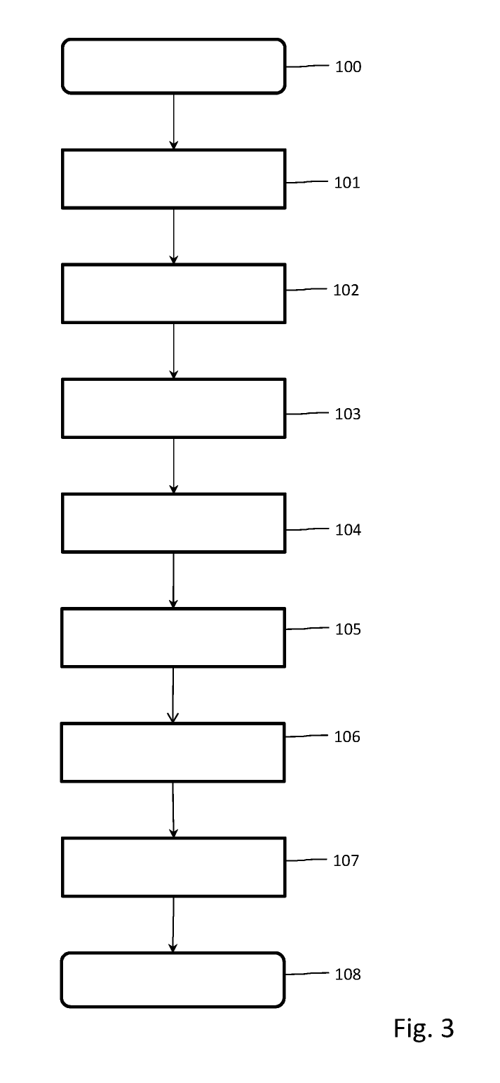

FIG. 3 shows a flow diagram of a measuring method according to the invention. Important sub-steps of the measuring method are illustrated on the basis of a concrete measurement situation in FIG. 4 to FIG. 6 as explained in greater detail further below. Geometric variables of an examination object 3 are measured by the measuring method. The measuring method shown in FIG. 3 can be performed for example by the measuring apparatus 1 shown in FIG. 1 and FIG. 2. The measuring apparatus 1 and the processor 7 thereof are correspondingly configured for this purpose.

The method is firstly initialized in step 100. This can be carried out for example by switching on a turn-on button implemented on the measuring apparatus 1, said button not being illustrated in more specific detail in FIG. 1 and FIG. 2.

In step 101, a sequence of images of the examination object 3 is then recorded. For this purpose, by way of example, a multiplicity of images can be recorded in each case from different positions by the measuring apparatus 1. For this purpose, the user merely has to proceed to different locations and in each case record an image of the examination object 3 from said locations.

In step 102, robust features 9 (cf. FIG. 4), such as, for example, a colour of an area that contrasts with the background, are then detected in a computer-aided manner. This is carried out by feature recognition from the images of the sequence that were recorded in step 101. By way of example, a SURF (Speeded Up Robust Features) algorithm or a SIFT (Scale-invariant feature transform) algorithm can be employed for this purpose.

In step 103, by use of the robust features 9 extracted in step 102, in particular using descriptors for the robust features 9, corresponding image regions 11 among the images are then identified in a computer-aided manner and a 3D model is then generated in a computer-aided manner from the result of the identification. Image registration methods, in particular, can be used for this purpose. By way of example, an algorithm known by the designation structure-from-motion method is also suitable.

In step 104, from the sequence of images recorded in step 101, precise features 13 (cf. FIG. 5), such as, for example, a point feature (e.g. a corner of a window) or a line feature (e.g. an edge of a house wall), are then detected in a computer-aided manner by a method for detecting corners and/or edges. By way of example, a Harris corner detector algorithm and/or an algorithm known by the designation Good-Features-To-Track can be used for this purpose. For edge detection, it is possible to use the ed-lines algorithm, for example, besides other algorithms.

In step 105, the precise features are assigned among the images and their 3D coordinates are calculated, such that they can be fitted into the three-dimensional model. The precise features are thus available in the model for further use.

In step 106, a set of precise features 13 is then selected from the precise features 13 detected in step 104. For this purpose, in particular, the precise features 13 detected in step 104 can be output for the user of the measuring method for selection, for example on the display 19 of the measuring apparatus 1. A selection can then be carried out for example with the aid of a controllable cursor or by using a touchscreen technology.

In step 107, finally, the desired geometric variable h (for example a length or a surface area) is calculated in a computer-aided manner in the 3D model from the set of precise features 13 that was selected in step 106. For this purpose, in particular, firstly for the set of precise features 13 that was selected in step 106, associated 3D coordinates in the 3D model can be calculated in a computer-aided manner, preferably with subpixel accuracy, in particular using descriptors of the precise features 13 and/or photometric similarities between the images of the sequence. This in particular also allows a suitable geometric object 21 to be fitted automatically or in a manner selected by the user. This can be carried out in various ways, as already described in greater detail above. For monitoring, an inaccuracy measure can be evaluated, which can be followed by follow-up measures, as already described in greater detail above.

In step 108, the method is ended, in particular by the measuring apparatus 1 being switched off. However, it is possible to jump to step 106 for the new selection of further precise features for calculation of further measurement variables.

Before the method is ended in 108, a further method step (not explicitly illustrated) can be performed, in which the 3D model is scaled by a reference object and/or a distance measurement.

A description is given below by way of example, on the basis of a concrete measurement situation illustrated in FIG. 4 to FIG. 6, of the measurement of a geometric variable h by an exemplary embodiment of the measuring method according to the invention using the measuring apparatus 1 shown in FIG. 1 and FIG. 2.

Specifically, the explanation as follows illustrates how—besides other measured geometric variables—the height h of the upper window 10 of the house façade 12 (cf. FIG. 4 to FIG. 6), said height being identified by the letter “h”, can be determined.

Firstly, a sequence of images of the house façade 12 is recorded from different perspectives by the camera 5 of the measuring apparatus 1.

The processor 7 then determines from the sequence of images, by a suitable algorithm, such as, for instance, SIFT or SURF, robust features, which are illustrated in FIG. 4 and FIG. 6 and are provided in part with the reference numeral 9. The images are then brought to correspondence by image registration and a 3D model is calculated.

Furthermore, precise features, which are illustrated in FIG. 5 and FIG. 6 and are provided in part with the reference numeral 13, are determined by corner and edge detection and displayed on the display 19. It is evident from FIG. 5 that in particular the corners and boundary lines of the house façade 12, of the windows, including the upper window 10, and of the door are detected as a result.

Since the user is interested in the height h of the upper window 10, via the touch-sensitive display 19 said user then selects the set of precise features 13 comprised by the upper window 10 by said user touching the display 19 at the location of the window 10 with a finger. Corresponding 3D coordinates of the selected precise features 13 are then calculated from the 3D model. Due to touching the display 19 at the location of the window 10, the user is given a proposal to fit a rectangle into the window 10 comprised by the selected precise features 13. If the user follows this proposal, the measuring apparatus 1 calculates the geometric variables that characterize the rectangle to be fitted. The values thus determined also include the height h of the window 10, said height being reproduced alongside other characteristic variables on the display 19. The user can also choose some other geometric object that is intended to be fitted, for example a circle, a segment, a triangle, a polygon, a three-dimensional body, such as a pyramid or a parallelepiped.

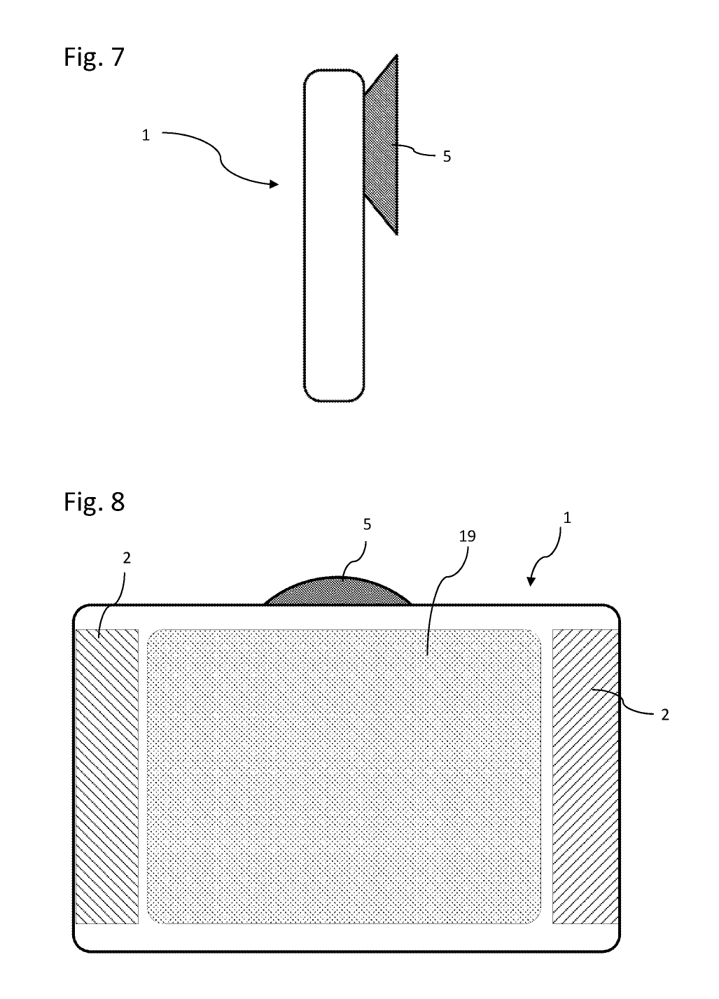

An alternative embodiment of a measuring apparatus 1 according to the invention is shown in FIG. 7 and FIG. 8. The measuring apparatus 1 here has a substantially parallelepipedal housing, in which a camera 5 is arranged. At the two sides, the measuring apparatus 1 has in each case a handle region 2, at which the measuring apparatus 1 can be held. A large display 19 is arranged between the handle regions, on which display the model created is able to be represented. Besides the exemplary embodiments shown here, a measuring apparatus according to the invention can have many further different configurations, for which reason the invention is in no way restricted to the forms illustrated.

The invention relates to a measuring apparatus 1 for measuring at least one geometric variable h, and to a corresponding measuring method. The measuring apparatus 1 is preferably designed as a handheld apparatus for creating a dimensional measurement of an examination object 3. The measuring method according to the invention is distinguished by the fact that from a sequence of images, preferably recorded by a camera 5, both robust features 9 and precise features 13 to be distinguished therefrom in a regular manner are detected, such that a robust 3D model is created and precise information about the geometric variable h to be measured is calculated.

### LIST OF REFERENCE SIGNS

1 Measuring apparatus
2 Handle region
3 Examination object
4 Head of 1
5 Camera
6 Foot of 1
7 Processor
9 Robust feature
10 Window
11 Image region
12 House façade
13 Precise feature
15 Selection device
17 Power supply unit
19 Display
21 Geometric object
23 Scaling unit
25 Point feature
27 Line feature
100 Initialization
101 Image recording
102 Detection of robust features
103 Generation of a 3D model
104 Detection of precise features
105 Assignment of the precise features
106 Selection of precise features
107 Calculation of a geometric variable
108 End of method

1. A measuring apparatus (1) for measuring at least one geometric variable of an examination object (3), comprising a camera (5) for recording a sequence of images of the examination object (3), a processor (7) configured for computer-aided detection of robust features (9) by feature recognition from the images of the sequence, wherein the robust features (9) include contents that are suitable for identification of corresponding image regions (11) among the images of the sequence, and configured for computer-aided identification of the corresponding image regions (11) among the images by the detected robust features (9) and computer-aided generation of a 3D model from a result of the identification, the processor is further configured for computer-aided detection of precise features (13) by at least one of corner or edge detection from the images of the sequence, and a selection device (15) configured for selecting a set of precise features (13), the processor (7) is further configured for computer-aided calculation of a geometric variable (h) from the set of precise features (13) in the 3D model.

2. The measuring apparatus according to claim 1, wherein the processor is configured to carry out the edge detection of the precise features using straight line or segment detection, and subsequent intersection point calculation.

3. The measuring apparatus according to claim 1, wherein the measuring apparatus (1) is a handheld apparatus in which at least one of the camera (5) or the processor (7) is integrated, and further comprises a power supply (17) for at least one of the camera (5) or the processor (7) integrated therein.

4. The measuring apparatus according to claim 1, wherein the processor (7) is configured for calculation of 3D coordinates in the 3D model at least for the set of precise features (13), or the selection device (15) is configured for outputting the extracted precise features (13) for a user, and the selection device (15) comprises a touch-sensitive display (19).

5. The measuring apparatus according to claim 1, wherein the processor (7) is configured for fitting a geometric object (21) into the 3D coordinates of the set of precise features (13) for the calculation of the geometric variable (h), including the processor (7) being configured for determining and outputting suitable geometric objects (21) in a computer-aided manner for selection.

6. The measuring apparatus according to claim 5, wherein the processor (7) is configured for evaluating an inaccuracy measure from the geometric object (21) that is fitted and the 3D coordinates of the set of precise features (13) and is additionally configured for at least one of issuing warning information or for automatically fitting an alternative geometric object (21) if the evaluated inaccuracy measure exceeds a limit value.

7. The measuring apparatus according to claim 1, wherein the processor (7) is configured for extracting descriptors for the robust features (9) for the identification of the corresponding image regions (11).

8. The measuring apparatus according to claim 1, wherein the processor (7) is configured for at least one of a registration of the images of the sequence or for applying a structure-from-motion method to the images of the sequence for the generation of the 3D model.

9. The measuring apparatus according to claim 1, wherein the processor (7) is configured for extracting descriptors of the precise features (13) for the calculation of the 3D coordinates of the set of precise features (13).

10. The measuring apparatus according to claim 9, wherein the processor (7) is configured for calculation of the 3D coordinates based on photometric similarities of the precise features (13) among the images of the sequence using the descriptors of the precise features (13).

11. The measuring apparatus according to claim 1, wherein the processor (7) is configured for subpixel-accurate calculation of the 2D coordinates of the precise features in the images.

12. The measuring apparatus according to claim 1, further comprising a scaling unit (23) configured for scaling the 3D model by at least one of evaluating a reference object recorded in the images of the sequence or by at least one distance measurement with respect to the examination object (3).

13. A measuring method for measuring at least one geometric variable (h) on an examination object (3), comprising the following steps:
recording a sequence of images of the examination object (3),
computer-aided detection of robust features (9) by of feature recognition from the images of the sequence using a processor, in which the robust features (9) include contents suitable for identification of corresponding image regions (11) among the images of the sequence,
computer-aided identification of corresponding image regions (11) among the images by the robust features (9) that are extracted and computer-aided generation of a 3D model from the result of the identification,
computer-aided detection of precise features (13) by at least one of corner or edge detection from the images of the sequence,
selecting a set of precise features (13), and
computer-aided calculation of the geometric variable (h) from the set of precise features (13) in the 3D model.

14. The measuring method according to claim 13, further comprising determining the precise features (13) as intersection points of edges f from the edge detection using straight line or segment detection.

15. The measuring method according to claim 13, further comprising calculating, at least for the set of precise features (13) associated 3D coordinates in the 3D model in a computer-aided manner, and outputting the detected precise features (13) for a user for selection.

16. The measuring method according to claim 13, further comprising, for calculation of the geometric variable (h), fitting a geometric object (21) into the 3D coordinates of the set of precise features (13) in a computer-aided manner, including offering suitable geometric objects (21) that are determined in a computer-aided manner to a user for selection.

17. The measuring method according to claim 16, further comprising evaluating an inaccuracy measure from the fitted geometric object (21) and the 3D coordinates of the set of precise features (13), and issuing warning information or automatically fitting an alternative geometric object (21) if the evaluated inaccuracy measure exceeds a limit value.

18. The measuring method according to claim 13, further comprising extracting descriptors for the robust features (9) in a computer-aided manner for identification of the corresponding image regions (11).

19. The measuring method according to claim 13, further comprising, for generation of the 3D model, bringing the images of the sequence into registration in a computer-aided manner or applying a computer-aided structure-from-motion method to the images of the sequence, or both.

20. The measuring method according to claim 13, further comprising for calculation of the 3D coordinates of the set of precise features (13), extracting descriptors of the precise features (13) in a computer-aided manner.

21. The measuring method according to claim 20, further comprising calculating the 3D coordinates based on photometric similarities of the precise features (13) among the images of the sequence, including on the basis of descriptors of the precise features (13).

22. The measuring method according to claim 13, further comprising calculating the 3D coordinates with subpixel accuracy.

23. The measuring method according to claim 13, further comprising using at least one of point features (25) or line features (27) as the precise features (13).

24. The measuring method according to claim 13, further comprising calculating scaling of the 3D model in a computer-aided manner by evaluating a reference object recorded in the images of the sequence or by at least one distance measurement with respect to the examination object (3), or both.
